(19) United States
(12) Patent Application Publication
(10) Pub. No.: US 2009/0245757 A1
(43) Pub. Date: Oct. 1, 2009

(54) RECORDING SYSTEM WITH CONTINUOUS RECORDING FUNCTION

(75) Inventor: CHANG-CHIANG LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/134,228

(22) Filed: Jun. 6, 2008

(30) Foreign Application Priority Data
Mar. 28, 2008 (CN) 200810300768.5

(51) Int. Cl. H04N 7/26

(52) U.S. Cl. 386/124; 386/E05.001

(57) ABSTRACT

A recording system used in an electronic device includes a setting module, a recording module, a timing module, a warning module, a storage module and an activating module. The setting module is configured for setting an on/off parameter, an early-warning time, a starting time and an end time of a recording. The recording module is configured for making the recording at the starting time. The timing module is configured for determining a remaining time of the recording. The warning module is configured for comparing the remaining time with the early-warning time, and outputting a warning notification if the remaining time is less than the early-warning time. The storage module is configured for storing the recording. The activating module is configured for reading the on/off parameter and determining whether to activate the recording module to continue for next recording according to the on/off parameter when the recording has concluded.

### BACKGROUND

1. Field of the Invention

The present invention relates to a recording system with a continuous recording function.

2. Description of the Related Art

Generally, electronic devices such as digital cameras, camcorders, and recorders have a time-activated recording function, in which an audio and/or a video recording is initiated at a pre-determined time, and stopped after a pre-determined time interval. However, during the recording, the user may not be nearby, therefore, when the current recording has concluded, the user is not able to continue for the next recording in time. This may result in an incomplete recording.

What is needed, therefore, is to provide a recording system used in an electronic device, in which the above problem is eliminated or at least alleviated.

### SUMMARY

An exemplary recording system used in an electronic device includes a setting module, a recording module, a timing module, a warning module, a storage module and an activating module. The setting module is configured for setting an on/off parameter, an early-warning time, a starting time and an end time of a recording. The recording module is configured for making the recording at the starting time. The timing module is configured for determining a remaining time of the recording. The warning module is configured for comparing the remaining time with the early-warning time, and outputting a warning notification if the remaining time is less than the early-warning time. The storage module is configured for storing the recording. The activating module is configured for reading the on/off parameter and determining whether to activate the recording module to continue for next recording according to the on/off parameter when the recording has concluded.

Other advantages and novel features of the present invention will become more apparent from the following detailed description of exemplary embodiments when taken in conjunction with the accompanying drawings.

### BRIEF DESCRIPTION OF THE DRAWINGS

FIG. 1 is a functional block diagram of a recording system according to an exemplary embodiment.

FIG. 2 is a flowchart of a recording method which can be performed by the recording system of FIG. 1.

### DETAILED DESCRIPTION OF THE EMBODIMENTS

References will now be made to the figures to describe an exemplary embodiment in detail.

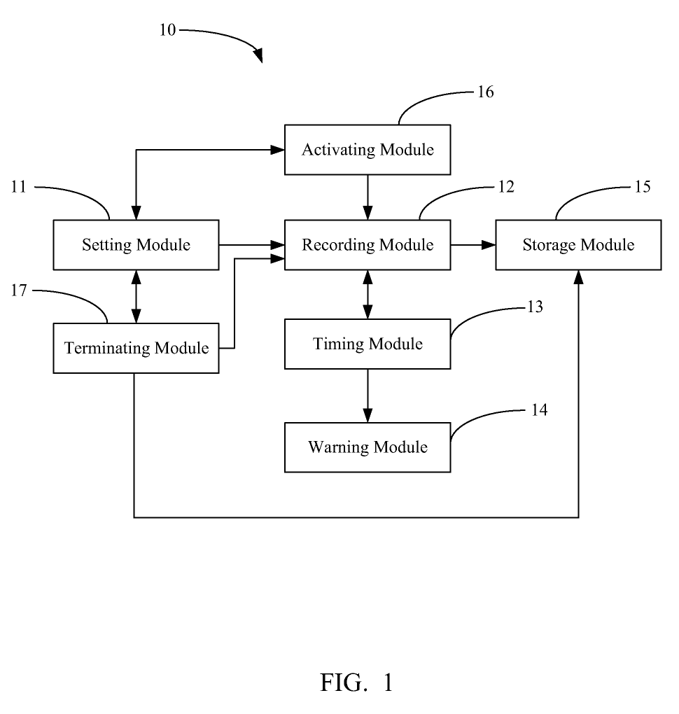

Referring to FIG. 1, a recording system 10 used in an electronic device, according to an exemplary embodiment, is shown. The electronic device may be a recorder, a cell phone, a digital camera, or a camcorder. Here in the exemplary embodiment, the electronic device is a camcorder. The recording system 10 includes a setting module 11, a recording module 12, a timing module 13, a warning module 14, a storage module 15, an activating module 16, and a terminating module 17.

The setting module 11 is configured for setting an on/off parameter, an early-warning time, a starting time and an end time of a recording. A user of the electronic device may set the on/off parameter, and the related time using the setting module 11. The on/off parameter may be a first value, in which the recording system 10 may be activated, and a second value, in which the recording system 10 may be deactivated. The early-warning time, which may either be set by a manufacturer or a user of the electronic device, is, for example, 1 minute. A starting time of a continuous recording is the end time of a current recording, and the length of the continuous recording is equal to that of the current recording by default.

The recording module 12 is configured for making the recording at the starting time of the recording. The recording may be an audio recording, a video recording, or a multimedia recording. The timing module 13 is configured for determining the remaining time of the recording (a current recording) based on the total duration and the elapsed time of the current recording. The warning module 14 is configured for determining whether the remaining time is less than the early-warning time, and outputting a warning notification if the remaining time is less than the early-warning time. In this exemplary embodiment, if the remaining time of the current recording is less than 1 minute, the warning module 14 outputs the warning notification. The warning notification may be an audio warning, such as beeps emitted by a speaker of the electronic device, and/or a visual warning message shown in a display of the electronic device. When a user of the electronic device has been warned, he may select an option (“Yes” or “No”) using the setting module 11 by pressing a functional key on the electronic device. When the user selects the “Yes” option, the setting module 11 receives the user's input, and may set the on/off parameter as the first value. When the user select the “No” option, the setting module 11 receives the user's input, and may set the on/off parameter as the second value. When the user doesn't select an option, the on/off parameter is set to a default on/off parameter, which herein is the first value.

The storage module 15 is configured for storing recordings. The storage module 15 may be an internal memory or an additional memory card installed in the electronic device. The activating module 16 is configured for reading the on/off parameter and determining whether to activate the recording module 12 to continue for next recording, i.e. making the continuous recording, according to the on/off parameter when the current recording has concluded. As mentioned above, the on/off parameter is set according to the user's input or the default setting. The activating module 16 activates the recording module 12 to make the continuous recording if the on/off parameter is set as the first value, or deactivates the recording module 12 if the on/off parameter is set as the second value.

The terminating module 17 is configured for terminating the recording if the size of the recording is greater than the available storage space of the storage module 15.

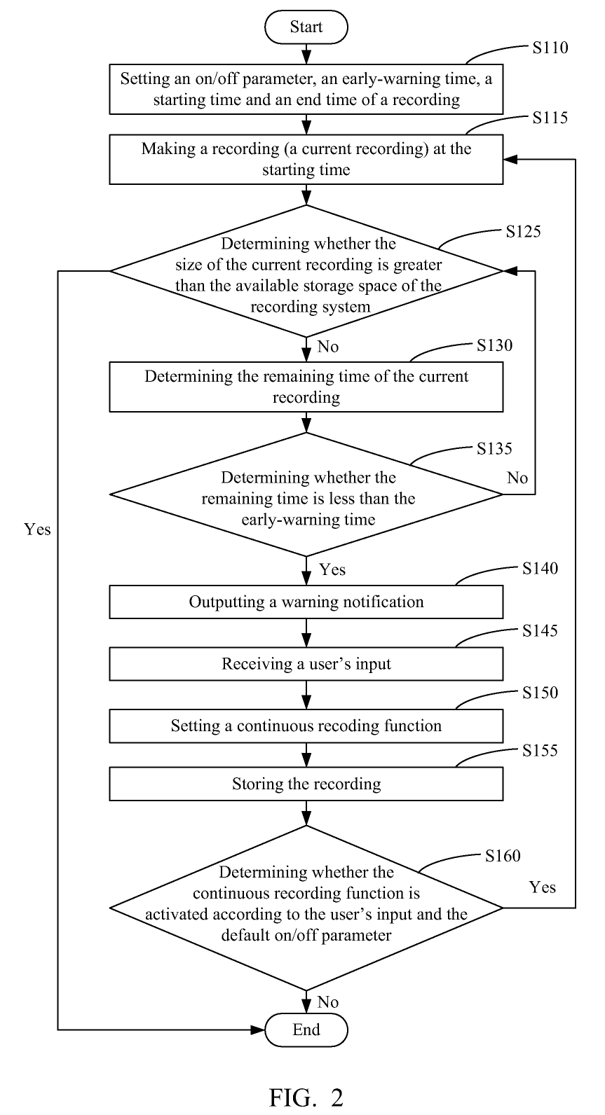

Referring to FIG. 2, a flowchart of a method for continuing a recording is shown. The method includes the following steps: setting an on/off parameter, an early-warning time, a starting time and an end time of a recording (S110), making a recording (a current recording) at the starting time (S115), determining whether the size of the current recording is greater than the available storage space of the recording system (S125), determining the remaining time of the current recording (S130), determining whether the remaining time is less than the early-warning time (S135), outputting a warning notification if the remaining time is less than the early-warning time (S140), receiving a user's input (S145), setting a continuous recording function (S150), storing the recording (S155), determining whether the continuous recording function is activated according to the user's input and the default on/off parameter (S160).

In step S110, the setting module 11 sets the on/off parameter, the early-warning time, the starting time and the end time of the recording according to the user's input. In step S115, the recording module 12 makes the recording at the starting time. In step S130, the timing module 13 determines the remaining time of the current recording based on the total duration and the elapsed time of the current recording.

In steps S135 and S140, the warning module 14 determines whether the remaining time is less than the early-warning time and outputs the warning notification if the remaining time is less than the early-warning time.

In steps S145, S150 and S160, the setting module 11 receives the user's input to set the on/off parameter. The activating module 16 activates the recording module 12 to continue for the recording (make a continuous recording) according to the on/off parameter. If the on/off parameter is set as the first value, the recording is continued at the end time of the current recording. If the on/off parameter is set as the second value, the recording concludes at the end time of the current recording.

In step S125, if the size of the current recording is greater than the available storage space of the recording system, the terminating module 17 terminates the recording. In step S135, if the remaining time is greater than the early-warning time, step S125 is executed.

In summary, before a current recording has concluded, a warning notification is outputted to remind the user. A continuous recording may be initiated according to the user's current option or a default on/off parameter. This results in a user-friendly recording system that avoids incomplete recordings.

It is to be understood, however, that even though numerous characteristics and advantages of the present invention have been set forth in the foregoing description, together with details of the structure and function of the invention, the disclosure is illustrative only, and changes may be made in details, especially in matters of shape, size, and arrangement of parts within the principles of the invention to the full extent indicated by the broad general meaning of the terms in which the appended claims are expressed.

What is claimed is:

1. A recording system used in an electronic device, comprising:
a setting module configured for setting an on/off parameter, an early-warning time, a starting time and an end time of a recording;
a recording module configured for making the recording at the starting time;
a timing module configured for determining a remaining time of the recording;
a warning module configured for comparing the remaining time with the early-warning time, and outputting a warning notification if the remaining time is less than the early-warning time;
a storage module configured for storing the recording; and
an activating module configured for reading the on/off parameter and determining whether to activate the recording module to continue for next recording according to the on/off parameter when the recording has concluded.

2. The recording system as claimed in claim 1, further comprising a terminating module configured for terminating the recording if the size of the recording is greater than the available storage space of the storage module.

3. The recording system as claimed in claim 1, wherein the on/off parameter includes a first value, in which the recording system is activated, and a second value, in which the recording system is deactivated.

4. The recording system as claimed in claim 1, wherein the warning notification includes at least one of an audio warning and a visual warning.

5. The recording system as claimed in claim 1, wherein the recording is one selected from the group consisting of an audio recording, a video and a multimedia recording.

6. A recording method of a recording system, comprising:
setting an on/off parameter, an early-warning time, a starting time and an end time of a recording;
making the recording at the starting time;
determining a remaining time of the recording;
comparing the remaining time with the early-warning time;
outputting a warning notification if the remaining time is less than the early-warning time; and
determining whether to continue for next recording according to the on/off parameter.

7. The method as claimed in claim 6, before determining the remaining time of the recording, further comprising:
terminating the recording if the size of the recording is greater than the available storage space of the recording system.

8. The method as claimed in claim 5, before determining whether to continue for next recording according to the on/off parameter, further comprising:
receiving a user's input to reset the on/off parameter.

9. The method as claimed in claim 8, further comprising determining whether to continue for next recording according to a default on/off parameter if the user's input is absent.
